(19) United States
(12) Patent Application Publication
(10) Pub. No.: US 2026/0267784 A1
(43) Pub. Date: Sep. 10, 2026

(54) AUTOMATIC ISSUE DETECTION AND APPLICATION OF SOLUTIONS

(71) Applicant: Oracle International Corporation, Redwood Shores, CA (US)

(72) Inventors: Amogha Bhardwaj, Redwood City, CA (US); Chidambaram Gopal Karthik Murugan, Redwood City, CA (US); Leena Daptardar, Redwood City, CA (US)

(73) Assignee: Oracle International Corporation, Redwood Shores, CA (US)

(21) Appl. No.: 19/069,638

(22) Filed: Mar. 4, 2025

(51) Int. Cl. G06F 11/3698

(52) U.S. Cl. CPC G06F 11/3698

(57) ABSTRACT

In some embodiments, a system, article, and computer-implemented method are disclosed for analyzing and addressing issues. A natural language description of a particular issue is accessed and encoded to a particular issue vector embedding. A database is accessed which includes a plurality of issues associated with a plurality of different issue pattern vector embeddings. Distances are determined for pairs of the particular issue vector embedding and one or more individual issue pattern vector embeddings of the plurality of different issue pattern vector embeddings to determine a similarity. Information identifying the one or more issues are displayed with one or more sets of responsive actions associated with the one or more issues. Feedback is received indicating that a selected issue of the one or more issues is the particular issue and that selected actions are responsive to the particular issue. Weights for the selected actions are adjusted.

### BACKGROUND

In the process of software development and execution, issues or errors may be encountered within software for a variety of reasons. Issues may be caused by errors within the code of the software such as typos, flaws within the design of the code, or inaccurate assumptions about how the code is expected to interact with other code. Such issues in the code are difficult to find and may go unnoticed, beyond the point of compiling the source code, testing the software, or executing the software in production. Issues may then be detected as the issues cause unexpected functionality or inhibit expected functionality of the software. For software used in automation, issues may halt the automation causing further issues.

When an issue is detected, such as at the point that an issue prevents further processing of the software, the software may store information about the issue such as a diagnostic file including information about the issue and previous processes performed by the software that may indicate a source of the issue. The diagnostic file alone does not indicate a solution for an issue or even an exact point within the code that is the source of the issue. Even after hours of review, a user may be unable to determine a solution for the issue even with the diagnostic file in hand.

### BRIEF SUMMARY

In some embodiments, a system, article, and computer-implemented method are disclosed for analyzing and addressing issues. A natural language description of a particular issue is accessed and encoded to a particular issue vector embedding. A database is accessed which includes a plurality of issues associated with a plurality of different issue pattern vector embeddings. Distances are determined for pairs of the particular issue vector embedding and one or more individual issue pattern vector embeddings of the plurality of different issue pattern vector embeddings to determine a similarity. Information identifying the one or more issues are displayed with one or more sets of responsive actions associated with the one or more issues. Feedback is received indicating that a selected issue of the one or more issues is the particular issue and that selected actions are responsive to the particular issue. Weights for the selected actions are adjusted.

In a particular embodiment, a computer-implemented method includes accessing a request including a natural language description of a particular issue, encoding at least the natural language description of the particular issue to a particular issue vector embedding based at least in part on a model for an embedding space, and accessing a database including a plurality of issues associated with a plurality of different issue pattern vector embeddings as encoded by a model for the embedding space. The computer-implemented method further includes determining a similarity between one or more issues of the plurality of issues and the natural language description of the particular issue based at least in part on distances determined for pairs of the particular issue vector embedding and one or more individual issue pattern vector embeddings of the plurality of different issue pattern vector embeddings. The one or more issue pattern vector embeddings include encodings of the one or more issues. The computer-implemented method further includes causing display of information identifying the one or more issues and one or more sets of responsive actions stored in association with the one or more issues, receiving feedback indicating that a selected issue of the one or more issues is the particular issue. The selected issue is stored in association with one or more particular sets of responsive actions of the one or more sets of responsive actions and causing display of information identifying one or more particular actions in the one or more particular sets of responsive actions. Performance of the one or more particular actions is predicted to address the particular issue based at least in part on the determined similarity. The computer-implemented method further includes receiving feedback indicating that a selected one or more particular actions addresses the particular issue and adjusting a weight of the selected one or more particular actions for the selected issue based at least in part on the feedback.

In a further embodiment, one or more of the plurality of different issue pattern vector embeddings are based at least in part on one or more stored diagnostic files associated with one or more of the plurality of issues. The computer-implemented method further includes receiving input from a request handling user, the input including additional details about an identified issue of the plurality of issues. The computer-implemented method further includes storing the input in association with the identified issue, and causing an updated vector embedding to be generated for the identified issue.

In the same or a different further embodiment, the one or more particular actions include one or more automated actions, and the feedback includes feedback on whether to perform the one or more automated actions in response to the feedback.

In another embodiment that extends the particular embodiment or any further embodiment, the one or more particular actions include one or more automated actions, and the feedback includes feedback to automatically perform the one or more automated actions in response to other requests about the particular issue.

In another embodiment that extends the particular embodiment or any further embodiment, the computer-implemented method further includes determining that one or more automated actions cannot be performed without additional user approval. The one or more particular actions include the one or more automated actions, and the feedback includes the additional user approval.

In another embodiment that extends the particular embodiment or any further embodiment, the one or more particular actions include one or more automated actions, and the feedback includes feedback to request user approval before performing the one or more automated actions in response to other requests about the particular issue.

In another embodiment that extends the particular embodiment or any further embodiment, the one or more particular actions include one or more automated actions, and the feedback includes feedback that user approval is not needed before performing the one or more automated actions in response to other requests about the particular issue.

In another embodiment that extends the particular embodiment or any further embodiment, the computer-implemented method further includes determining that one or more automated actions can be performed without additional user approval based at least in part on a history of feedback about the one or more automated actions. The one or more particular actions include the one or more automated actions that are performed based at least in part on the request before the receiving the feedback.

In another embodiment that extends the particular embodiment or any further embodiment, the computer-implemented method further includes determining that one or more automated actions can be performed without additional user approval based at least in part on a configurable setting stored in association with the one or more automated actions. The one or more particular actions include the one or more automated actions that are performed based at least in part on the request before the receiving the feedback.

In another embodiment that extends the particular embodiment or any further embodiment, the encoding, the accessing, the determining, and the adjusting are performed by a vector database that stores vector embeddings in association with data and retrieves subsets of data similar to input based at least in part on the stored vector embeddings and a vector embedding of the input.

In another embodiment that extends the particular embodiment or any further embodiment, the request is a user-to-user message from a first user on a messaging platform. The user-to-user message is ingested by an issue resolution platform via an application programming interface. The causing display is performed in a user session for a second user on the issue resolution platform.

In another embodiment that extends the particular embodiment or any further embodiment, the plurality of issues and plurality of different issue pattern vector embeddings are stored in an issue database that is initialized with an initial knowledge base for analyzing issues, determining the similarity is performed after attaching the issue database to an existing operational pipeline for handling issues, and the initial knowledge base comprises information gathered outside of the existing operational pipeline.

In another embodiment that extends the particular embodiment or any further embodiment, the method is performed as part of a microservice added to an existing operational pipeline, the particular issue is an issue reported in the operational pipeline, and the accessing is performed in response to the detection of the particular issue within the operational pipeline.

In another embodiment that extends the preceding embodiment or any further embodiment, the microservice includes an endpoint which is triggered on an event completion of a software execution cycle of the operational pipeline, the plurality of issues and plurality of different issue pattern vector embeddings are stored in an issue database that is initialized with an initial knowledge base for analyzing issues, the computer-implemented method further includes automatically storing the particular issue, the particular issue vector embedding, and metadata related to the particular issue in the issue database.

In another embodiment that extends the particular embodiment or any further embodiment, the computer-implemented method further includes receiving feedback indicating a user-entered one or more particular actions addresses the particular issue and storing the user-entered one or more particular actions in association with the selected issue.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory and/or transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items or separate process instances of a set of process instances. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for analyzing issues and suggesting solutions.

FIG. 2 illustrates a system diagram showing an example cloud infrastructure for analyzing issues and suggesting solutions.

FIG. 3 illustrates a diagram of an example user interface for receiving issues to analyze and return suggested solutions.

FIG. 4 illustrates a diagram of an example user interface for receiving user feedback of a suggested solutions.

FIG. 5 illustrates a diagram of an example user interface for editing issue patterns and suggested solutions for an issue database.

FIG. 6 depicts a simplified diagram of a distributed system for implementing certain aspects.

FIG. 7 is a simplified block diagram of one or more components of a system environment by which services provided by one or more components of an embodiment system may be offered as cloud services, in accordance with certain aspects.

FIG. 8 illustrates an example computer system that may be used to implement certain aspects.

### DETAILED DESCRIPTION

In various embodiments, a method for analyzing issues and presenting solutions includes generating a vector embedding of a received issue diagnostic file and comparing the generated vector embedding to a set of candidate issue embeddings to determine a similar issue pattern and display corresponding solutions. In some embodiments, the method further includes receiving user feedback for the similar issue pattern or the corresponding solutions and adjusting weights thereof for future searches. In various embodiments, the issue analysis system is implemented using non-transitory and/or transitory computer-readable storage media to store instructions which, when executed by one or more processors of a computer system, cause display of a user interface and processing of received input to analyze issues and present solutions. The issue analysis system may be implemented on a local or cloud-based computer system that includes processors and a display for showing the user interface to a user for analyzing issues and presenting solutions. The computer system may communicate with client computer systems for analyzing issues and/or presenting solutions.

A description of an issue analysis system or method is provided in the following sections:
DIAGNOSTIC FILE INGESTION
GENERATING ISSUE VECTOR EMBEDDINGS
MOST SIMILAR ISSUE DETECTION
PRESENTING SOLUTIONS TO DETECTED ISSUES
AUTOHEALING OF DETECTED ISSUES
AUTOHEALING OF ISSUES IN CI/CD ARCHITECTURE
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Diagnostic File Ingestion

Occasionally, issues occur on device(s) operating in the access-restricted network. An issue is an occurrence or incident of a failure, error, exception, or unexpected processing path or output of software and/or hardware that is otherwise operating with a purpose, such as to complete a task which may not have been completed due to the issue. The cause of an issue is an underlying problem, and a single problem may cause multiple issues. Issues can occur in any software or hardware, and information about these issues may be logged in diagnostic files. As non-limiting examples, issues can occur on application components, middleware components, database components, or using other more specific logical resources such as particular libraries, classes, objects, functions, containers, registers, stack frames, interfaces, events, memory chunks, assembly instructions, SQL queries or clauses, etc. that may be more closely related to the underlying problem in those high-level software components. Issues may also occur throughout a continuous integration and continuous deployment process for fusion applications and their release management lifecycle, in which case the stage of the release management lifecycle may be relevant to the cause of the issue.

The methods described herein may be implemented throughout a software development cycle or at various points within a continuous integration and continuous deployment process for fusion applications. The methods described herein may be performed as a microservice to an existing operational pipeline at any point throughout the operational pipeline. Performance of the methods described herein may be in response to the detection of an issue either as a step of the method or after detection of an issue by a user or a separate service which may call the microservice to perform the method for the detected issue within the operational pipeline. The microservice may comprise an exposed endpoint which may be triggered on an event completion of a software execution cycle of the operational pipeline in order to call the microservice and perform the method.

More generally, a logical resource is any identifiable resource used or referenced by software during operation or in diagnostic files that result from operation. These logical resources may be mentioned or referenced in the diagnostic files generated as a result of logged operation of the software or otherwise as a result of the issue, and information about the way these logical resources were being used at the time of the issue, the values assigned to or produced by different logical resources, the status of the logical resources, and/or the interactions between logical resources is helpful for understanding what caused the issue. That said, a single diagnostic file could reference tens, hundreds, or even thousands of different logical resources that were in use by the software at the time of the issue, and many or all of these referenced logical resources may be irrelevant to the underlying problem that caused the issue. That said, one or a few of these referenced logical resources may provide enough information to diagnose and fix the problem and hopefully to avoid any future issues caused by the problem.

Information that describes the issue may be compiled into an issue pattern. The issue pattern may comprise one or more diagnostic files or data derived from a diagnostic file. For example, an issue pattern may store one or more most important terms or keywords derived from a diagnostic file for an issue. When determining the nature of the issue encountered, the issue pattern may be referenced as a representation of the issue such as to compare with other issue patterns to find a matching or similar issue.

The issue may or may not trigger an error message that identifies the issue. Even if an error message is triggered, the error message may not be uniquely mapped to a known solution, without more information. An error message may be a form of diagnostic file or other issue information. More commonly, an error message may indicate that an issue has been encountered and that a diagnostic file has been generated for the issue. One example of an error message may be a compiler error indicating a line of untranslated code at which an issue occurred in the compiling process along with other information about the issue such as related functions to the issue. In this example, the compiler error may be stored as a diagnostic file within the issue pattern to determine the source of the issue in the untranslated code.

Another example of a diagnostic file may be a stack trace, memory dump, or other process data capture that is generated when encountering an issue in an active process, optionally by the active process itself. A stack trace provides detailed information about the function or method calls that occurred prior to an issue in the execution of a program. The stack trace may provide details about the particular function or method call where the issue occurred within the execution including function parameters or relevant local variables. The stack trace may further provide details about function or method calls that preceded the particular function or method call in the execution of the program as well as pointers to track function execution and a return address for where execution may resume or saved registers used to restore to a previous state of the process. The collection of function or method calls that the stack trace describes are the call stack for the program. An example stack trace with an example call stack is provided below:

```
Example Stack Trace:
XTSYM Triage Info
Type: TRC
ASSIGNEE: qerhn.c - CHULIN
SIGNALING FUNCTION: qerhn_kxhrPack
ABSTRACT: ORA-600 [kxhrPack:cv12], [12], [5], [2]
FILE:
diag/rdbms/em31pod/em31pod1/incident/incdir_32341534/em31pod1_ora_166187_i323415
34.trc
SQLTEXT:
WITH
SAWITH0 AS (select T358730 as c1,
From
  DIM575 T358730 /* SP02_D */
Where ( T358730 = ‘02’),
SAWITH1 AS (select count (distinct T358456.JDE) as c1,
From
  (
    (
STACK SIGNATURE: 0xda8f3bb1a56ed40b
STACK SIGNATURE (partial): 0x1d0e4ccd3ebce8f7
Example Call Stack:
dbgexProcessError < dbgePostErrorKGE < dbkePostKGE_kgsf < kgeadse <
kgerinv_internal < kgerinv < kgeasnmierr < qerhn_kxhrPack < qerhnSplitBuild <
qervwRowProcedure < qerghFetch < qervwFetch < rwsfcd < qerhnFetch < qervwFetch <
qerghFetch < qervwFetch < rwsfcd < qerhnFetch < qerghFetch < qervwFetch <
qersoProcessULS < qersoFetchSimple < qersoFetch < qeervwFetch < qercoFetch <
qerrcFetch < opifch2 < opifch < opiodr < ttcpip < optsk < opiino < opiodr < opidrv <
sou2o < opimai_real < ssthrdmain < main < _libc_star_main
```

The stack trace may be presented in a syntax or structure other than natural language; however, the stack trace may still encode information about the issue and associated function or method calls with language describing features of the issue. For example, the stack trace may include a general statement of the issue such as “Exception in thread ‘main’ java.lang.NullPointerException.” The general statement may contain standard elements such as the preamble “exception in thread” which do not encode information as useful for determining the source of an issue as information presented about the issue such as the file name, error code, or variable or function names. A stack trace may be used in a debugging tool such as GDB or WinDbg which can interpret the raw data of a stack trace into a human-readable stack trace in natural language. A stack trace may be edited in order to remove syntax or language that does not provide semantic weight for the purposes of detecting the encountered issue prior to storing as part of the issue pattern. For example, a stack trace may be converted to a natural language format and/or parsed by applying a set of rules to remove known terms or symbols without identifying value for the encountered issue.

A user may, upon encountering an issue, interact with a user interface for determining solutions to software issues. The user may submit a query to an issue analysis system regarding the issue encountered to receive solutions for that issue. For example, the user may, within a user interface, select an encountered issue diagnostic file received or generated from the encountering of the issue. The encountered issue diagnostic file may then be processed by the issue analysis system which stores data derived from the encountered issue diagnostic file in an encountered issue pattern. In another alternative, the user may upload or submit the encountered issue diagnostic file received from a program to a user interface such as a web application or messenger service such as Slack. For example, the user may submit a request in a user-to-user message on a messenger service including the diagnostic file as part of the request. The web application or messenger service may use an API of the issue analysis system to submit a query on behalf of the user. The query may include the encountered issue diagnostic file. In yet another alternative, the issue analysis system may detect that the user is describing an issue encountered such as in a message in a user-to-user messenger service and, in response, automatically determine a diagnostic file generated for the encountered issue. The issue analysis system may determine, upon receipt of the encountered issue diagnostic file, a language of the software code to use as a software language setting. The software language setting may determine a number of settings for facilitating interpretation of the software code and diagnostic file based on features or specifics of the software language used. A number of parsers or language interpretation agents may be selected for extracting meaningful information from the encountered issue diagnostic file or the software code where the number of parsers or language interpretation agents are specific to the software language of the software language setting. A particular encoding model may be selected from a plurality of candidate encoding models based on the software language setting wherein the particular encoding model is specific to the software language of the software language setting such as by the particular encoding model being only trained on code of the software language of the software language setting.

The issue analysis system may receive further diagnostic files representing metadata about the encountered issue, the system that encountered the issue, or other software, processes, or systems related to the encountered issue. For example, the system may receive, in addition to a diagnostic file representing a stack trace of an encountered issue, a user generated description of the encountered issue in natural language. The user generated description may be used by the issue analysis system as a further diagnostic file describing the encountered issue. Alternatively, the issue analysis system may automatically generate or access, in response to receiving a diagnostic file, further diagnostic files representing metadata about the encountered issue, the system that encountered the issue, or other software, processes, or systems related to the encountered issue. For example, the issue analysis system may, in response to receiving a diagnostic file representing a description of an issue within an integrated software, automatically access one or more systems or software integrated with the integrated software and receive further diagnostic files describing the encountered issue generated by the one or more systems or software which are then stored as part of the encountered issue pattern.

The issue analysis system may use a number of parsers or language interpretation agents to extract important information about the encountered issue diagnostic file. For example, a parser applied to the encountered issue diagnostic file may be a rule for determining an issue code from the encountered issue diagnostic file. The rule for determining an error code may be to select a word at a certain position within the encountered issue diagnostic file, such as the word or phrase at the end of the first line of the encountered issue diagnostic file. After determining an error code for the encountered issue diagnostic file, the error code may be used to adjust settings for the issue analysis system such as weights for a vector embedding or to trigger further parsers or language interpretation agents specific to the error code. Alternatively, the error code may be used as a further diagnostic file for the encountered issue. Another parser may contain a number of rules for determining relevant software code files or a relationship between relevant software code files. For example, a parser for detecting relationships between software code files may determine a current software code file within which the issue occurred based on the encountered issue diagnostic file. The parser may further determine a second software code file related to the execution of the current software code file by a certain relationship. The parser may, for example, determine that the second software code file performed a function call that executed code within the current software code file before the issue was encountered. The issue analysis system may then use the current software code file and/or the second software code file as a further diagnostic file stored in the issue pattern for the encountered issue.

The issue analysis system may apply a language interpretation agent to determine functionality, user intent, or other useful information from the software code. A language interpretation agent may be an agent containing a set of rules or a model specific to the software language of the software language setting. A language interpretation agent may, for example, contain a large language model used for interpreting one or more items of functionality of software code. The language interpretation agent may determine one or more items of functionality of software code by taking as an input the encountered issue diagnostic file and/or a number of files of software code. The language interpretation agent may automatically generate a prompt to prompt the large language model to determine one or more items of functionality within the encountered issue diagnostic file or software code files. A prompt generated by the language interpretation agent may include as part of the prompt the encountered issue diagnostic file and/or the number of files of software code. An item of functionality determined by a language interpretation agent may be stored to be used for validating or assisting in a determination of the issue encountered by the user or may be used as a further diagnostic file and stored in the encountered issue pattern for the encountered issue.

A parser or language interpretation agent may determine a number of keywords from the encountered issue diagnostic file. The keywords may be a number of most important or most commonly used keywords for the diagnostic file, such as specialized classes, methods, functions, variables, filenames, libraries, or other string references within a diagnostic file. In one example, the keywords may be determined by applying a word frequency detection algorithm for determining a number of most frequently used terms in the encountered issue diagnostic file. In another example, a parser may detect function calls, importing software libraries, accesses to other files, or other instances where the software code accesses external resources. This may be performed by parsing the language for certain known keywords such as comparing to a set of libraries or whitelist of words known to indicate a unique issue, or by applying natural language processing techniques such as named entity recognition. In another example, a language interpretation agent may use natural language processing such as part of speech tagging or text-ranking algorithms to determine a number of keywords based on the usage of the keyword in the encountered issue diagnostic file. In yet another example, a language interpretation agent may generate a prompt to a large language model, including the encountered issue diagnostic file, to determine a number of keywords from the encountered issue diagnostic file. The number of keywords may be stored as part of the issue pattern in association with the encountered issue diagnostic file and may be referenced when searching an issue database or may be used as a further diagnostic file.

### Generating Issue Vector Embeddings

The issue analysis system may, after initial parsing, encode the encountered issue pattern and any further diagnostic files into a vector embedding. The encoding may be performed by using a vector embeddings encoding model trained on labeled software code or diagnostic file data. For example, a vector embeddings encoding model may be trained on diagnostic file data labeled with corresponding semantic labels indicating semantic features of the data. The trained vector embeddings encoding model may take as an input the issue pattern comprising one or more issue diagnostic files and generate as an output a vector embedding comprising weighted embeddings in a latent space representing semantic information within the issue diagnostic file(s). The generated vector embedding of the one or more encountered issue patterns may be used as an encountered issue vector embedding to represent semantic information about the issue encountered. The encountered issue vector embedding may be stored in association with the one or more encountered issue diagnostic files for use in searching against an issue database.

The vector embeddings encoding model may also account for context of the issue occurrence. The issue database may record, at the time of receiving the diagnostic file, context data describing the issue occurrence of the issue encountered. Context data describing the issue occurrence of the issue encountered may be, for example, a phase of the software within which the issue occurred such as a build or compile phase, a phase of a project the software is a part of such as development or debugging phases, or a condition of the system running the software in which the issue occurred. The context data may be recorded by first accessing the system data of the system running the software or the log data of the project or software. The context data may also be received from a user uploading additional files including log files along with the diagnostic file. The context data may be accounted for in the vector embeddings encoding model such as by including a log file as input and representing the context as part of the vector embedding. The context data may also be used as a flag or indicator for the vector embedding such as to perform an initial sort or filtering of candidate matching vector embeddings. The context data may be stored in the issue database in association with the generated vector embedding for the encountered issue.

The vector embeddings encoding model may also account for data derived by parsers or language interpretation agents as part of the issue pattern. The vector embedding encoding model may take as an input, along with the diagnostic file, data from a parser and/or a language interpretation agent derived from the diagnostic file as part of the issue pattern. For example, the vector embedding encoding model may also take an error code as an input, where the error code is derived from a parser by applying a rule to the diagnostic file to determine a word, phrase, or number representing an error code for the issue that cause the generation of the diagnostic file as part of the issue pattern. In the same or a different example, the vector embedding encoding model may also take an item of functionality as an input as part of the issue pattern, where the item of functionality is determined by a language interpretation agent from the diagnostic file.

### Most Similar Issue Detection

After generating a vector embedding for the encountered issue, the encountered issue vector embedding may be compared against an issue database, containing vector embeddings of known issue patterns, by a vector similarity search to identify a closest known issue. The issue database is a searchable database containing descriptions of known issues and issue patterns with corresponding solutions. The issue database may be first bootstrapped or populated by input of a subject matter expert. The subject matter expert may be a request handling user that populates the issue database by defining a plurality of issues which may occur in software programming and may be submitted as requests by other users. For example, the subject matter expert may select a set of known error codes used for a specific software language or compiler. The subject matter expert may then define a vector embedding for each of the issues entered to the issue database. The subject matter expert may define a vector embedding by generating a vector embedding of an issue pattern comprising a description, documentation, example of an issue, or error code. Alternatively or in addition, the subject matter expert may define a set of labels such as semantic labels that are included in the generation of the issue pattern vector embedding.

A subject matter expert may initialize the issue database from an initial knowledge base to support a process for determining issues not within the initial knowledge base as part of a software pipeline. In this way, the software pipeline may benefit from the addition of the initial knowledge base in analyzing the further issues not within the initial knowledge base. The initial knowledge base may be a set of issues defined by the subject matter expert or may be derived from another knowledge base outside of the software pipeline. The initial knowledge base may not encompass all possible issues that may be submitted for analysis and solution recommendation, in which case the initial knowledge base may be used as part of a process for determining further issues not within the initial knowledge base. The issue database may be initialized with the initial knowledge base prior to comparing issues submitted by other users. For issues submitted that are not within the initial knowledge base, a most similar issue may be determined from the initial knowledge base and corresponding solutions for the most similar issue may be presented. An issue determined to not be within the initial knowledge base may be stored and later reviewed by a subject matter expert for adding to the issue database.

A subject matter expert may modify issues and solutions stored in the issue database. For example, a subject matter expert may add additional information for an issue pattern stored in the database such as additional details, context data, or additional files related to the issue. In this way, the additional information may be accounted for in a similarity search against the issue which may lead to a more accurate similarity measurement to the current encountered issue.

The generated vector embedding for the encountered issue may be compared against the issue database by performing a nearest neighbor search or other search algorithm across the issue database, at each step performing a vector similarity comparison between the generated vector embedding for the encountered issue and an existing vector embedding for a candidate issue pattern of the issue database. The vector similarity comparison may be, for example, a vector distance calculation such as a cosine similarity calculation. By performing a vector similarity comparison for each candidate issue pattern vector embedding of the issue database and comparing the resulting calculated similarity to the encountered issue vector embedding, one or more most similar candidate issue may be determined. An example search algorithm across the issue database may be a comparison of a similarity measure to a predefined threshold. Issues with a similarity measure of the issue pattern vector embedding and the encountered issue vector embedding that passed the threshold value may be stored as a candidate similar issue. Another example search algorithm may be a nearest neighbor search performed by performing a cosine similarity search for each issue pattern vector of the issue database and comparing the similarity measure of the calculated cosine similarity to a current saved most similar similarity measure of a current most similar candidate issue. If the calculated cosine similarity is smaller than the current most similar candidate issue cosine similarity, then the current candidate issue is stored as the new most similar candidate issue. This process is repeated until all candidate issues of the issue database have been compared and the current most similar candidate issue is returned as the most similar candidate issue.

The candidate issue pattern vector embeddings may first be sorted or filtered prior to searching through for a generated encountered issue vector embedding. Context data associated with the generated vector embedding of the encountered issue may be used to first filter or sort the candidate issue pattern vector embeddings. Context data representing a phase of the software or project in which the issue was encountered may be used to filter the candidate issue pattern vector embeddings to only search through candidate issue pattern vector embeddings relevant to that context. For example, context data associated with an issue may represent the issue was encountered during a compiling phase of the software in which the issue was encountered. The candidate issue pattern vector embeddings may be filtered to only search candidate issue pattern vector embeddings representing an issue which may be encountered in the compiling phase. Candidate issue pattern vector embeddings may also be sorted or filtered based on an error code associated with the issue encountered, such as an error code determined by parsing the diagnostic file.

Similarity between the encountered issue vector embedding and any candidate issue pattern vector embedding of the issue database may be determined by applying any distance algorithm across the issue database. A distance algorithm may be performed between the encountered issue vector embedding and each candidate issue pattern vector embedding of the issue database to determine a distance between the two vectors. The distance between the vector embedding of the encountered issue and a candidate vector embedding encoded from issue patterns stored in the database defines a similarity between the two compared vectors and a corresponding similarity between the encountered issue and the candidate issue pattern of the database. By performing a similarity comparison between the encountered issue vector embedding and each candidate issue pattern vector embedding of the issue database, a nearest neighbor search may be used to find a list of most similar candidate issues to the encountered issue.

The distance or similarity analysis may be performed on the whole vector embedding or by breaking up vectors into components to determine correlation of corresponding components across the vectors. For example, the encountered issue vector and a candidate issue pattern vector may each include a component that indicates an error code returned by a compiler when encountering a compiler error that encodes both a type of issue and an error-specific code. The type of issue may be correlated across vectors even though the rest of the error code is not correlated. The column correlation may be determined by comparing the correlation determined according to as the similarity measure to a correlation threshold as a correlation criterion. The columns may be counted as correlated if the correlation measure exceeds the correlation threshold. In an alternative embodiment, the columns may be compared to determine correlation clusters, where columns are determined to be part of a cluster if the correlation between all combinations of columns in the cluster is above a certain threshold.

A variety of vector distance equations may be used, separately or in any combination, to determine a similarity between two vectors. Example vector distance equations are provided, and other vector distance equations may be used separately from or in combination with any of the provided examples.

A Pearson Correlation Coefficient between two vectors is calculated as a ratio between the covariance between the vectors and the product of the standard deviations between the two vectors. A correlation coefficient of 1 represents identical vectors, a correlation coefficient of −1 represents opposite vectors, and a correlation coefficient of 0 represents vectors that are not correlated.

A Cosine Distance or cosine similarity between two vectors is determined by calculating a cosine of the angle between the two vectors. A result of 1 represents a cosine similarity between two identical, a result of −1 represents a cosine similarity between two opposite vectors, and a result of 0 represents a cosine similarity between two unrelated or orthogonal vectors.

A Euclidean Distance is determined by calculating a square root of a sum of the squares of the distances between components of the two vectors. The higher the Euclidean distance, the lower the similarity between the components of the vectors used in the calculation.

A Manhattan Distance is calculated as a sum of the absolute differences between components of the vectors. The higher the Manhattan Distance, the lower the similarity between the components of the vectors used in the calculation.

A Minkowski Distance is calculated as the p-th root of the sum of the absolute differences between components of the vectors raised to a power, p, for each component pair. The Minkowski Distance equals the Manhattan Distance when p=1 and the Euclidean Distance when p=2. The higher the Minkowski Distance, the lower the similarity between the components of the vectors used in the calculation.

A Hamming Distance between two vectors is determined based on how many positions at which corresponding components of the vectors are different or sufficiently different. For each component pair in the vectors that are different, a counter is incremented. The Hamming Distance is the total counter for the vectors across all component pairs.

A Chebyshev Distance between two vectors is calculated as the greatest of the absolute differences among the vectors' corresponding components. The largest absolute difference among all the pairs of components is the Chebyshev Distance. The larger the Chebyshev Distance, the lower the similarity between the vectors.

A Jaccard Distance between two vectors is calculated as a ratio between the size of the intersection between the vectors (based on elements in common between the vectors) to the size of the union between the vectors (based on elements in either or both of the vectors). Jaccard Similarity is defined by the ratio, and Jaccard Distance is defined as one minus the Jaccard Similarity.

The Sørensen-Dice Similarity is calculated as two times the number of elements in common among the vectors divided by the sum of the number of elements in each vector. The Sørensen-Dice Distance is one minus the Sørensen-Dice Similarity.

For large issue databases, an approximate nearest neighbor search may also be performed by grouping vectors of the issue database. For example, searches of candidate issue pattern vectors of the issue database may be made faster by using graph techniques and grouping candidate issue pattern vectors based on certain dimensions of the vectors or certain semantics represented by subsets of dimensions of the vectors. In one example, the use of a certain variable within a plurality of candidate issue patterns may be represented by a common range of values for a certain dimension of the candidate issue pattern vector embeddings. A first step of performing a similarity search between the encountered issue vector and the candidate issue pattern vectors of the issue database may be to determine if the value of the certain dimension of the encountered issue vector is within the common range of values and, if so, searching only those candidate issue pattern vectors that also have a value for the certain dimension that is within the common range of values to determine the closest candidate issue pattern vectors.

Alternatively or in addition to grouping vectors by certain dimensions, vectors may be grouped by the existence of certain keywords, such as keywords determined from the encountered issue diagnostic file and stored in association therewith or in the encountered issue pattern. For example, searches of vectors of the issue database may be made faster by using graph techniques and grouping vectors based on whether one or more keywords are used within the diagnostic file corresponding to the candidate issue pattern vectors. In one example, the use of a certain variable within a plurality of candidate issue patterns may be detected as a use of a keyword and the corresponding vectors may be grouped for faster searching. The first step of performing a similarity search between the encountered issue vector and the candidate issue pattern vectors of the issue database may be to determine if one or more keywords exist within the encountered issue diagnostic file. One or more detected keywords of the one or more keywords may exist within the encountered issue diagnostic file. In performing a similarity search on the issue database, the search may be performed within only those candidate issue pattern vectors where the corresponding candidate issue pattern is determined to contain the same one or more detected keywords. Keywords for detection may be determined in advance of receiving an encountered issue diagnostic file, in which case the search for pre-determined keywords may be performed on all candidate issue patterns of the issue database such that all candidate issue patterns and their corresponding candidate issue pattern vectors may be labeled within the issue database with the keywords detected within the candidate issue pattern.

Alternatively, keywords may be detected from the encountered issue diagnostic file when received, such as by a means of detecting the use of certain variables, function calls, or file accesses within the encountered issue diagnostic file. In this case, a text search may be performed for the variable within the candidate issue diagnostic files of the issue database to determine a number of candidate issue pattern vectors as a group for the similarity search based on the detection of the keywords within the corresponding candidate issue diagnostic files. The search of candidate issue diagnostic files for a keyword detected from the encountered issue diagnostic file may be aided by first filtering results of the issue database by a certain dimension of the candidate issue pattern vectors determined to be the most affected by the presence of the keyword. For example, the encoder model may be used to generate a vector embedding of the keyword, and the largest dimension of the resulting vector embedding may be determined. The largest dimension of the keyword vector embedding may then be used as a keyword indicator dimension and candidate issue patterns of the issue database may be filtered based on the value of the keyword indicator dimension of the candidate issue pattern vector being above a certain threshold.

The encountered issue pattern and the context data may be used in an initial direct comparison to issue pattern and associated context data stored in the issue database to determine if there is an exact duplicate issue within the issue database. Each issue of the issue database may be compared to the encountered issue pattern directly, where any determined difference advances the search to the next entry of the issue database. The comparison may avoid or ignore elements of the issue pattern file determined to be non-dispositive for determining a duplicate issue pattern such as file names, user device identification information, or other variables which may differ between instances of the same software execution. Such non-dispositive elements may be elements common to all diagnostic files regardless of the issue encountered such as introductory language generically describing that an issue has been encountered. If an issue of the issue database is determined to be a duplicate of the encountered issue, the similarity vector search by be bypassed and the determined duplicate issue of the issue database maybe returned as the most similar candidate issue.

A determined most similar candidate issue may be presented to a user for confirmation. For example, the issue analysis system may display via a user interface, such as the interface used to submit a query of the issue encountered, a representation of the determined most similar candidate issue. The representation of the determined most similar candidate issue may be an issue description, written for the determined most similar candidate issue by a subject matter expert. The user may be prompted to submit feedback including a confirmation or rejection of the determined most similar candidate issue as the issue encountered. Upon receiving a confirmation or rejection by the user of the determined most similar candidate issue, the issue analysis system may store in the database the user feedback to adjust future searches through the issue database. The user feedback may, for example, be stored as an adjustment to a weight associated with the determined most similar candidate issue. The weight associated with the determined most similar candidate issue may be a likelihood weight used to order detected similar candidate issues. Alternatively, the weight associated with the determined most similar candidate issue may be a weight within the issue pattern vector embedding associated with the most similar candidate issue.

### Presenting Solutions to Detected Issues

After determining a most similar candidate issue or after confirmation of a similar candidate issue by a user, the issue analysis system may retrieve one or more stored solutions associated with the similar candidate issue that is predicted to address the similar candidate issue. Within the issue database, the issue analysis system may store one or more solutions in association with any given issue. The solutions may be initially populated by subject matter experts who define a solution for an existing issue of the database or define a solution to an issue when defining a new issue for the database. A solution may be an action or a series of actions that, when performed, are likely to solve the issue the solution is associated with. A solution may be presented as a narrative of actions for a user to perform, such as in the form of a suggested set of steps for the user to carry out. The solution may also include actions to be performed within the system affected by the issue, such as executable functions, commands, or code. The solution may be presented as a description of steps displayed in a user interface such as a user interface used to submit a query of the issue encountered. The user may then be prompted to complete the actions detailed in the solution. The solution may also be presented as a description of a set of executable functions, commands, or code. The user may be prompted to execute the executable functions, commands, or code or, alternatively, the user may be prompted to confirm the automatic execution of the executable functions, commands, or code by the issue analysis system.

An issue of the issue database may have more than one solution defined for that issue. When retrieving a solution for a given issue, the issue analysis system may determine if more than one solution exists associated with the given issue. The issue analysis system may, upon detection of multiple solutions for a given issue, display a representation of the plurality of solutions for the user such that the user may select a best solution for the issue encountered. The issue analysis system may display the solutions in a determined order, such as in a predefined order defined by a subject matter expert to be in an order that best addresses the issue. For example, a plurality of solutions retrieved for a particular issue may be retrieved in a predefined order that orders solutions with the least impact of performance first. In this way, a solution may be prioritized that will not cause other problems or consequences such as loss of data before a solution that may risk such problems or consequences. In another example, a plurality of solutions for a particular issue may be retrieved in a predefined order of likelihood of solving the issue.

If an encountered issue is not yet represented in the database, the issue analysis system may determine one or more most similar candidate issues that do exist within the database. The solutions associated with one or more most similar candidate issues may be accumulated and presented as solutions for the encountered issue. In accumulating solutions from a plurality of most similar candidate issues, the accumulated solutions may be displayed in order based on their corresponding weights for their associated issues. In the case that a solution is associated with a plurality of the most similar candidate issues, the solution may be displayed as a most likely solution, such as by displaying the solution higher in the order of accumulated solutions, such as by adding together the weights of the solution associated with each of the most similar candidate issues. If an encountered issue that is not yet represented in the database is detected, the issue may be stored in the database. An encountered issue that is not yet represented in the database may be stored with the associated accumulated solutions displayed for the encountered issue along with any feedback received for the accumulated solutions for the encountered issue.

After performance of a solution determined for the selected issue, the issue analysis system may receive feedback from the user regarding the solution. For example, the issue analysis system may cause the display of a user feedback prompt for a displayed solution such that the use may indicate whether the displayed solution solved the issue encountered. The user feedback prompt may be a selection of a positive or negative indication for the corresponding solution. If a plurality of solutions are to be displayed for the selected issue, the solutions may all be displayed each with their own user feedback prompts. Alternatively, a first solution of the plurality of solutions may be displayed with a corresponding user feedback prompt. If the user inputs a negative indication to the user feedback prompt, the feedback may be stored and a next solution of the plurality of solutions may be displayed with a corresponding user feedback prompt. A user feedback prompt may optionally be omitted from display based on a user indication against feedback such as if a user has not opted in for submitting feedback.

User feedback received by the issue analysis system regarding a solution for a selected issue may be stored in the issue database in association with the solution and the selected issue. The user feedback for a particular solution may also be stored as feedback that the selected issue is the encountered issue. The user feedback may be stored as a weight in the database for the paring of the solution and the selected issue. The weights stored for a solution-issue pairing may be used in determining an order or likelihood in determining whether a particular solution is the correct solution for a given issue. For example, when an issue is selected, the issue analysis system may retrieve the current weight scores for each of the solutions stored for the selected issue. Solutions may be displayed in the order of highest to lowest weight with the highest weight representing a solution currently most favored to be the correct solution for the selected issue. When the issue analysis system receives feedback from a user, this weight may be adjusted such as by incrementing the weight score in the case of positive feedback and decrementing the weight score in the case of negative feedback.

In one example, if an issue had solutions A, B, and C which have weights 5, 4, and 2 respectively, the solutions may be displayed in the order of decreasing weights: A, B, C. If two more users submit an issue that is identified to be the same issue and give feedback indicating B to be the correct solution for that issue, then the weight for B would be incremented twice and the weights for all solutions would now be A: 5, B: 6, and C: 2. For the next user that is presented with these solutions for the same identified issue, the solutions would be displayed in the order B, A, C in accordance with the new weights.

Users could give negative feedback, indicating that a particular solution is not a valid solution for the issue. In this case the weight for those solutions could be decremented. The weight for a solution may be decremented to the point that it is lower than another solution which may instead be presented as a candidate solution if a limited number of candidate solutions of the possible solutions are displayed or it may be decremented to a value below a threshold for displaying as a solution in which case the particular solution would no longer be displayed as a solution for future users submitting an issue detected to be the same issue. In the case that the user does not submit any feedback, the lack of feedback may indicate a type of feedback, such as a positive or negative indication, and weights may be adjusted accordingly.

User feedback may also be received as natural language text entered by the user as a suggested solution. When displaying solutions for the selected issue in a user interface, the user interface may provide a text box for entering natural language text. For example, the user interface may, in response to a user submitting feedback indicating all solutions displayed in the user interface are not the correct solution for the issue encountered, display the text box for receiving natural language user feedback of a suggested solution. Alternatively, the text box may be automatically displayed in response to receiving negative user feedback for all solutions displayed to the user.

In the case that a user submits negative feedback for the detected issue(s) or for the suggested solution(s), the issue analysis system may prompt the user to input additional information for running an additional similarity search. For example, upon receiving negative feedback for the detected issues, the issue analysis system may prompt the user to upload additional files related to the encountered issue such as code within which the issue occurred. In another example, the issue analysis system may prompt the user, in response to receiving negative feedback for all suggested solutions, to input a natural language description of the issue encountered. The additional information input by the user may be used to adjust the weights of the generated encountered issue vector embedding to generate a modified encountered issue vector embedding. The modified encountered issue vector embedding may be used in an additional similarity search through the issue database. In the case that a new detected similar issue or new suggested solution is determined from the additional similarity search, the new detected similar issue or new suggested solution may be presented to the user.

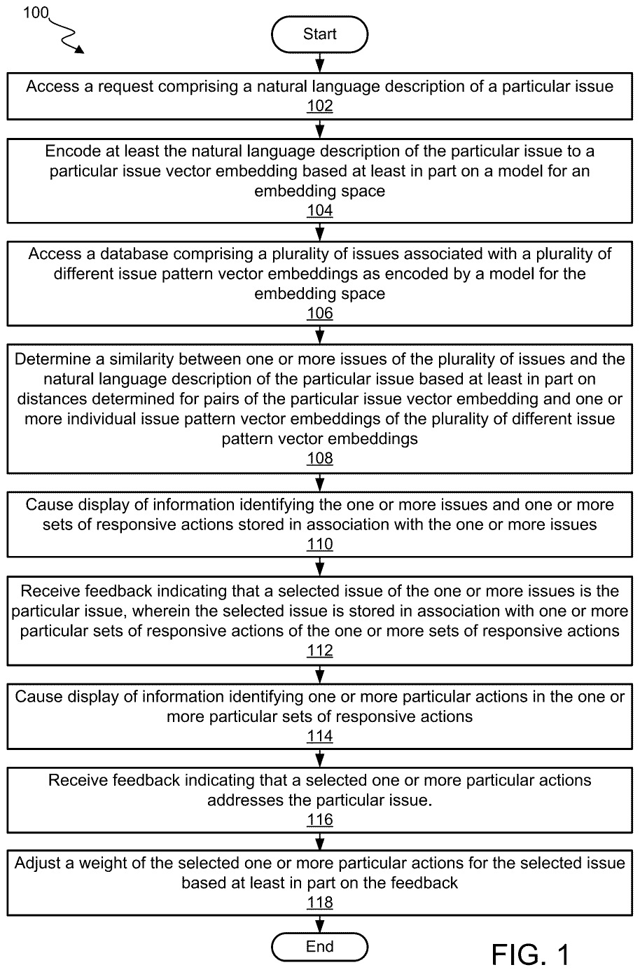

FIG. 1 depicts an example process 100 for analyzing software issues and suggesting solutions. At block 102, an issue analysis system accesses a request including a natural language description of a particular issue encountered, such as a software issue. At block 104, the issue analysis system encodes at least the natural language description of the particular issue to a particular issue vector embedding based at least in part on a model for an embedding space. The encoding may also account for additional information accessed by the issue analysis system or derived from the natural language description prior to encoding. At block 106, the issue analysis system accesses a database comprising a plurality of issues associated with a plurality of different issue pattern vector embeddings as encoded by a model for the embedding space, such as the model used for encoding the particular vector embedding. At block 108, the issue analysis system determines a similarity between one or more issues of the plurality of issues and the natural language description of the particular issue. The determination may be based at least in part on distances determined for pairs of the particular issue vector embedding and one or more individual issue pattern vector embeddings of the plurality of different issue pattern vector embeddings retrieved from the database. At block 110 the issue analysis system causes display of information identifying the one or more issues and one or more sets of responsive actions stored in association with the one or more issues, such as stored solutions for the one or more issues. At block 112, the issue analysis system receives feedback indicating that a selected issue of the one or more issues displayed is the particular issue described by the natural language description. Prior to the determination, the selected issue is stored in the database in association with one or more particular sets of responsive actions of the one or more set of responsive actions which may be accessed when accessing the selected issue. At block 114, the issue analysis system causes display of information identifying one or more particular actions in the one or more particular sets of responsive actions. At block 116, the issue analysis system receives feedback indicating that a selected one or more particular actions addresses the particular issue. At block 118, the issue analysis system adjusts a weight of the selected one or more particular actions for the selected issue based at least in part on the feedback.

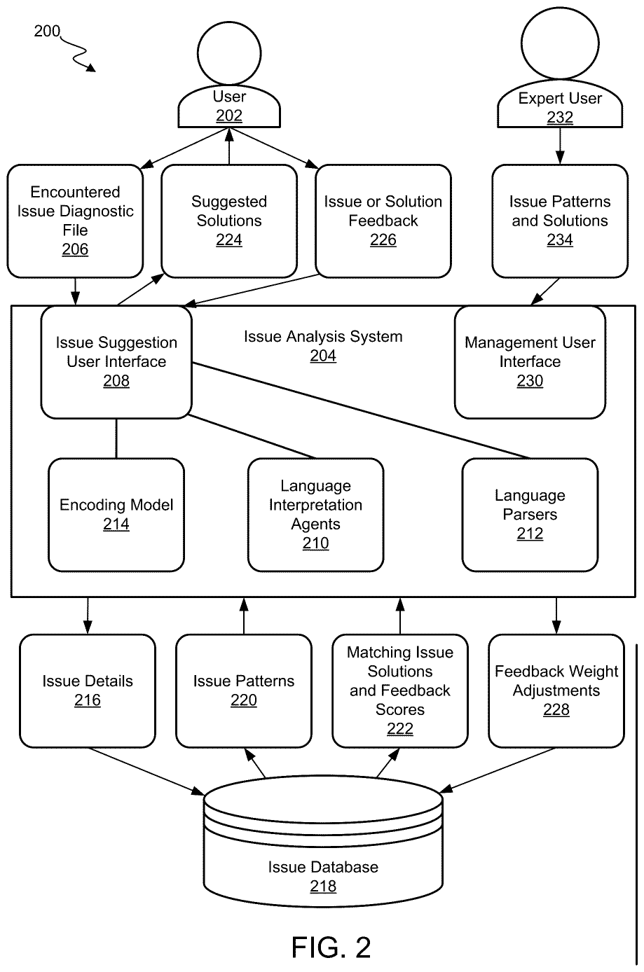

FIG. 2 depicts an example distributed system 200 for analyzing issues and presenting solutions. A user 202 may interact with an issue analysis system 204 when encountering an issue to seek a solution for the encountered issue. When the user 202 encounters an issue, the issue generates an encountered issue diagnostic file 206 encoding information about the issue. The user 202 uploads the encountered issue diagnostic file 206 to an issue suggestion user interface 208 of the issue analysis system 204. The issue analysis system 204 may store the issue diagnostic file in an issue pattern and/or extract information about the issue using one or more language interpretation agents 210 or language parsers 212 to be stored in the issue pattern. The encountered issue pattern, including the diagnostic file 206, is passed to an encoding model 214 for generating an encountered issue vector embedding. The issue analysis system 204 also passes the issue details 216 including the encountered issue diagnostic file 206, the encountered issue vector embedding, and any extracted information from the language interpretation agents 210 or language parsers 212 to an issue database 218 for storing. The issue database 218 is prompted to return a number of issue patterns 220 which the issue analysis system 204 compares to the generated encountered issue vector embedding to determine a most similar candidate issues from the issue patterns 220. The issue database 218 is prompted to retrieve the matching issue solutions and feedback scores 222 for the most similar candidate issues. The issue analysis system 204 uses the feedback scores to display suggested solutions 224 in rank order to the user 202 via the issue suggestion user interface 208. The user 202 may then implement the suggested solutions 224 in order to attempt to solve the encountered issue. The user 202 may submit solution or issue feedback 226 to the issue suggestion user interface 208. The issue analysis system 204 may then submit to the issue database 218 feedback weight adjustments 228 based on the solution or issue feedback 226. The issue analysis system 204 may also run an additional query to the issue database 218 for an additional search of candidate issues. The issue analysis system 204 also includes a management user interface 230 for a subject matter expert user 232 to utilize in submitting initial issue patterns and solutions 234 to populate the issue database 218. The subject matter expert user 232 may also use the management user interface 230 to edit entries of the issue database 218 such as editing the issue patterns 220 or matching issue solutions and feedback scores 222.

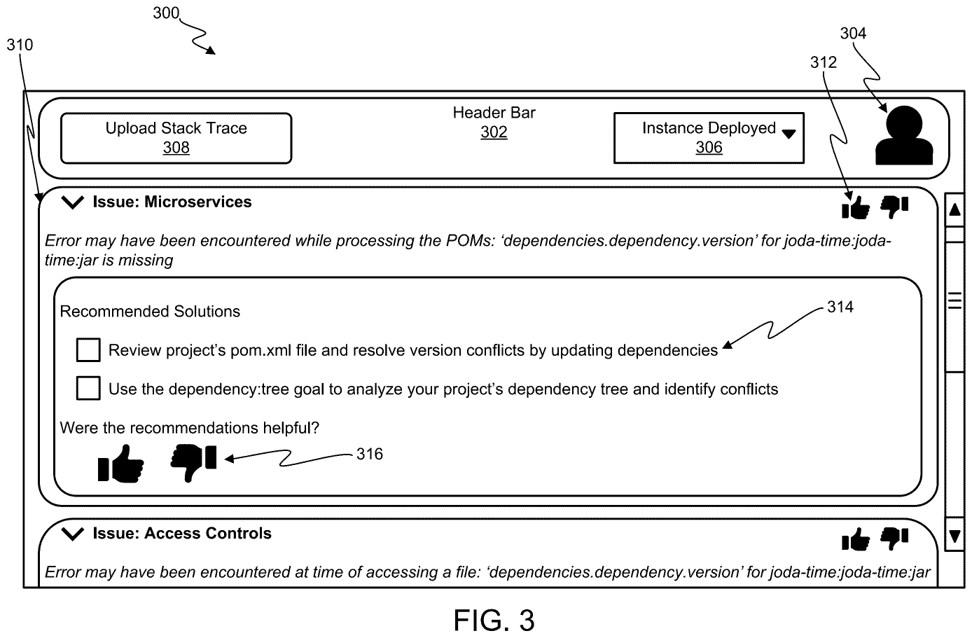

FIG. 3. depicts a user interface 300 may be used for displaying suggested solutions to the user. The user interface 300 may contain a header bar region 302 which may contain a number of settings for manipulating the user interface 300. The user interface 300 may detect a user 304 such as by a set of user credentials. The user interface 300 may be configured based on the user credentials such as by displaying different settings for the user 304 or by permitting use by the user 304 of the user interface 300. The user interface 300 may also include an issue source selection 306 such as a selection for the current instance deployed of the software within which an issue was encountered. The user interface 300 may include a diagnostic file selection option 308 for selecting or uploading a diagnostic file of an encountered issue to analyze and determine a number of solutions for. After analyzing a diagnostic file of an encountered issue, the user interface 300 may display a detected issue 310 including a description of the issue encountered such that the user may determine if the detected issue matches the encountered issue. The detected issue 310 may be displayed with an issue feedback option 312 for receiving user feedback as to whether the detected issue 310 matches the encountered issue. The detected issue 310 may be displayed with one or more recommended solutions 314 to solve the detected issue 310. The one or more recommended solutions 314 may be displayed with a description of the actions to perform for the one or more solutions 314. The one or more recommended solutions 314 may also be displayed with a solutions feedback option 316 for receiving user feedback indicating whether one or more of the recommended solutions were the correct solution for solving the encountered issue.

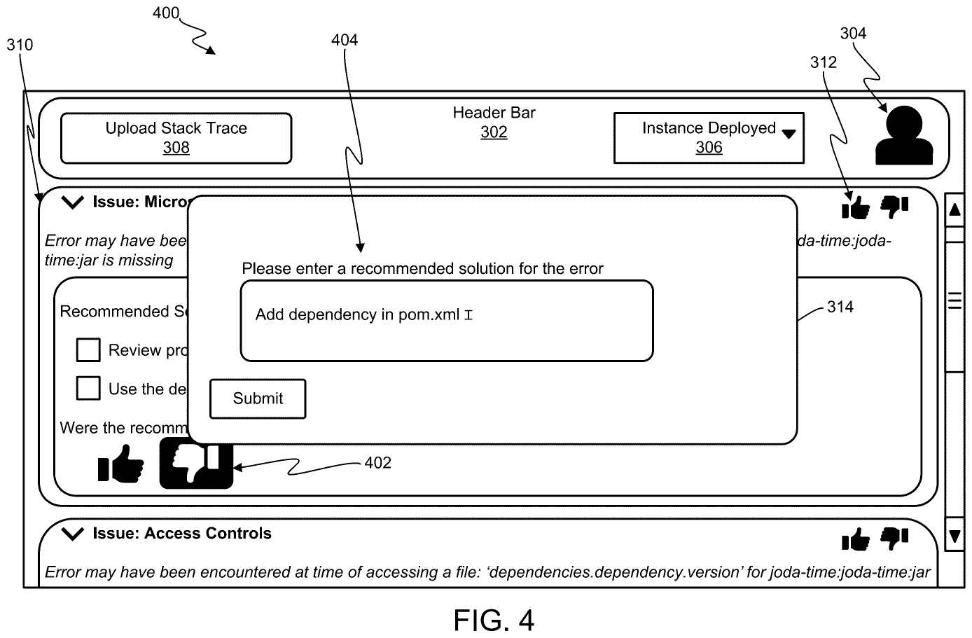

FIG. 4 depicts a user interface 400 which may be the same or a different user interface as the user interface 300. Upon receiving an indication of negative user feedback 402 for the recommended solutions 314, the user interface 400 may display a proposed solution option 404 for receiving user feedback suggesting a proposed solution for the detected issue 310.

The issue analysis system may comprise a management user interface for a subject matter expert to access to manage the detection of issues and presented solutions. For example, the subject matter expert may edit solutions within the issue database to better present the actions to perform. In another example, the subject matter expert may delete solutions that are inaccurate or remove an association between a solution and an issue when the solution is not a valid solution for the issue. In yet another example, the subject matter expert may associate a solution with an issue as a gold solution that is presented as a solution for the issue any time the issue is detected.

Suggested solutions entered by a user may be stored by the issue analysis system in the issue database. Suggested solutions may be stored such that they are not displayed as a candidate solution such as by storing the suggested solution with a flag indicating the source of the suggested solution is user feedback. Suggested solutions entered by a user may be reviewed and vetted by a subject matter expert to determine whether the suggested solution should be stored as a candidate solution for the associated issue. A subject matter expert may access a management user interface for managing issues of the issue database and stored solutions for each issue of the database. The subject matter expert may view the natural language text entered by the user as a suggested solution and determine whether the suggested solution should be made into a candidate solution for the issue or should be deleted as an invalid solution. The subject matter expert may make the suggested solution into a candidate solution by interpreting the natural language text into a new solution entry that is stored in association with the issue in the issue database. Alternatively, the subject matter expert may edit the natural language text entered by the user as a suggested solution and save the solution within the issue database in association with the issue by removing the flag indicating the source of the issue to be user feedback. Interpreting the natural language text into a new solution or editing the natural language text may include reformatting the text into a series of actions, editing the language of the text, or implementing suggested executable functions, commands, or code to be included in the solution. The subject matter expert may manually set a weight score for the new solution when storing the solution in the database to indicate the subject matter expert's estimation of the likelihood of the solution being the correct solution for the associated issue.

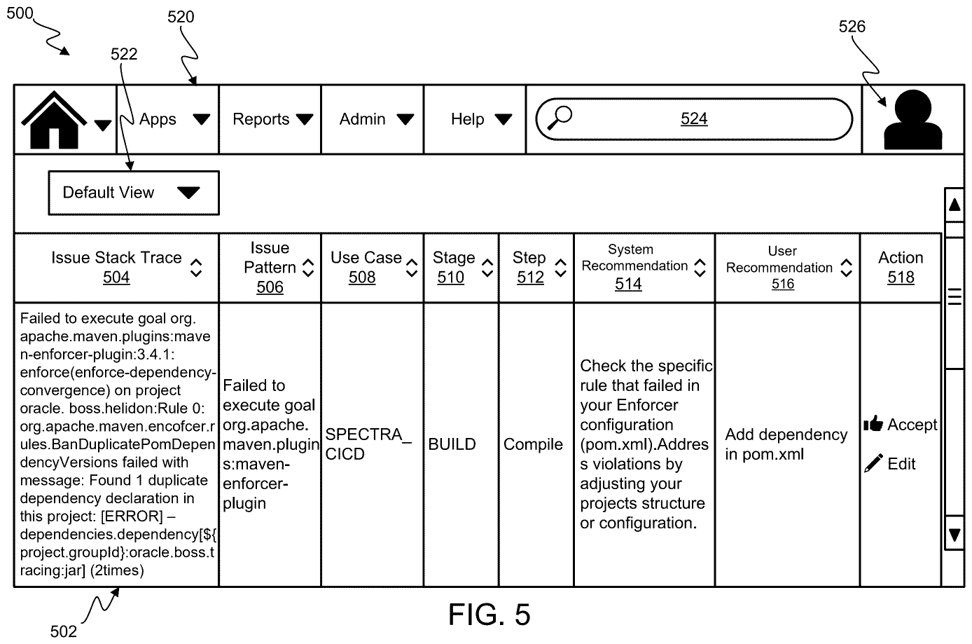

FIG. 5 depicts an example user interface 500 for allowing a subject matter expert to edit issue patterns and associated solutions. The user interface 500 displays issue data 502 of a particular issue. The issue data 502 may contain an issue diagnostic file 504 containing the entire language of an example issue diagnostic file generated when encountering the issue. The issue diagnostic file 504 may have been stored in the issue data 502 when encountering the particular issue. The issue data 502 may also contain an issue pattern 506 describing the particular issue which may be derived from the issue diagnostic file 504. The issue data 502 may also contain metadata of the particular issue including a use case 508, a stage 510, or a step 512 within which the particular issue was encountered. The issue data 502 may also store associated solutions for the particular issue. The issue data 502 may be a row of data representing a solution-issue pairing. The issue data 502 may contain a system recommendation 514, displaying a most likely solution determined by the issue analysis system for the particular issue. The issue data 502 may represent an instance of user feedback for the solution-issue pairing, in which case the issue data 502 may contain a user recommendation 516 for a solution to the particular issue. The user recommendation 516 may have been recorded after an instance of a user providing negative feedback to the system recommendation 514 for the particular issue. Associated with the user recommendation 516, the user interface 500 may display a number of action options 518, which the subject matter expert may select, such as for accepting the user recommendation 516 as a new solution, or editing the user recommendation 516 to create a new solution for the particular issue. The user interface 500 may contain a number of user interface controls 520 for controlling the currently displayed data, such as selections for viewing user recommendations 516 as issue-solution pairings, or for displaying all current solutions for a particular issue. The user interface 500 may also contain a display method setting 522 for controlling the method of displaying the currently selected data from the user interface controls 520 such as by filtering results. Another display method setting may be a search function 524 for filtering currently displayed data by a search entered by the subject matter expert. The user interface 500 may also recognize the subject matter expert as a particular user 526 such as via a set of user credentials. The set of user credentials may alter the available data for display or provide access control to the user interface 500.

### Autohealing of Detected Issues

Solutions may also include actions to be performed within the system affected by the issue, such as executable functions, commands, or code which may be implemented without the need for user action or intervention. The solutions may be implemented as an autoheal solution which may implement the included actions to be performed within the system affected by the issue as automated actions. A solution may be implemented as an autoheal solution after designation as an autoheal solution or after a certain rule has been satisfied.

A rule specified for an autoheal solution may require a threshold level of positive feedback from users before an autoheal solution may automatically be implemented. In this example, an autoheal solution may be designated, but not implemented automatically. A description of the actions may be provided to a user encountering the associated issue including a description of the executable functions, commands, or code to be implemented for the solution. The user may be prompted to submit feedback for the solution after manually implementing the executable functions, commands, or code for the solution. Feedback from one or more users implementing the solution may be recorded in association with the autoheal solution. The feedback may be positive feedback indicating the solution is the correct solution for the detected issue or the feedback may be positive feedback indicating that the solution should be implemented as an autoheal solution for the detected issue. User feedback for a solution may be stored in association with the solution-issue pairing, that is, the feedback may be stored and referenced only for instances of applying the solution for the detected issue and not for the same solution applied for a different issue. For a next user presented with the autoheal solution, the issue analysis system may check the current recorded user feedback associated with the autoheal solution against a threshold to determine if the threshold has been met. If the threshold of positive user feedback has been met, then the autoheal solution may be implemented automatically.

Another rule specified for an autoheal solution may require a threshold level of confidence in detecting the issue associated with the autoheal solution. For example, a rule may state that an autoheal solution may not be implemented for an issue unless the encountered issue is matched to the detected issue with a 75% certainty. The certainty of detection may be determined by the cosine similarity between the normalized vector embeddings of the encountered issue and the detected issue. In this way, a solution which may be associated with a plurality of issues may be implemented as an autoheal solution for only certain associated issues.

A candidate autoheal solution may be designated by a subject matter expert as an autoheal solution in order to automatically implement the autoheal solution for an associated issue. A subject matter expert may, at the time of defining a solution, designate the solution as an autoheal solution. Alternatively, a candidate autoheal solution may be detected by the issue analysis system and displayed for review by a subject matter expert. The subject matter expert may designate the candidate autoheal solution as an autoheal solution such as by confirming or adding a tag to the solution indicating it as an approved autoheal solution. The subject matter expert may, at the time of designating the autoheal solution, also define a rule for the autoheal solution such as a threshold issue confidence before automatically implementing the autoheal solution.

An autoheal solution may first prompt a user prior to automatically performing the actions of the solution. For example, a user may be prompted with a description of an automatically performed solution. The user may approve the description of the automatically performed solution, which may authorize the implementation of the autoheal solution. The autoheal solution may first prompt a user prior to automatically performing the actions of the solution in the case that the user has never accepted the autoheal solution. The issue analysis system may store a per-user setting to record whether a user has previously accepted the autoheal solution. For all subsequent cases of the user encountering an issue associated with the autoheal solution, the autoheal solution may be implemented automatically without first prompting the user.

The autoheal solution may instead first prompt a user prior to automatically performing the actions in response to a certainty of the detected issue being below a predetermined threshold. For example, an autoheal solution may be implemented automatically for any encountered issue matched to an associated detected issue with greater than a threshold certainty, however, for detected associated issues that are the most similar candidate issue but for which the certainty is below the threshold, the user may be prompted to accept automatic performance of the actions of the solution or the actions to perform may be displayed to the user for manual performance.

A user may store an individual setting that prohibits automatic implementation of autoheal solutions. When applying an autoheal solution automatically, the issue analysis system may first check for the existence of a setting for prohibiting automatic implementation of autoheal solutions. Alternatively, a user may indicate consent to autoheal solutions, in which case the issue analysis system may first check that a user has consented to autoheal solutions prior to applying autoheal solutions automatically.

### Autohealing of Issues in CI/CD Architecture

An issue may be encountered in a continuous integration and continuous deployment architecture. A continuous integration architecture is one in which changes to code are automatically integrated frequently. Continuous integration architecture may be effected by a version control system that automatically detects changes to code and may automatically commit changes. In automatically committing changes, the continuous integration architecture may also automatically perform tests to detect issues caused by the newly committed code. A continuous deployment architecture is one in which new commits, such as automatically committed code from a continuous integration architecture, are automatically deployed in a production environment. A continuous deployment architecture may contain monitoring tools for detecting issues in automatic deployment of code and rollback mechanisms for returning the production environment to a previous state to maintain uptime.

Within a continuous integration and continuous deployment architecture, issues may be detected either prior to or after committing changes and automatic implementation of the changes. Issues detected prior to committing changes may be detected in the continuous integration phase, such as by a test performed on the code as part of the continuous integration architecture. Issues detected after committing changes may be detected at the time of deployment in a production environment or issues that cause the production environment to crash or fail.

When detecting an issue in the continuous integration phase, an automatic commit of the code may be canceled and the issue analysis system may be accessed such as by sending the issue analysis system one or more diagnostic files. The one or more diagnostic files may be stack traces, metadata, or issue logs describing the issue and stored as an issue pattern. Metadata used as a diagnostic file may be version control information or other status information about the production environment in which the new code is or was to be deployed to. The one or more diagnostic files may also be unstructured data such as files, documents, or images generated by the continuous integration and deployment architecture to describe the issue or generated through the process of deployment that may be incomplete or flawed due to the issue such as test or sample output files. Metadata about the phase of the continuous integration and continuous deployment process may also be stored in association with the diagnostic files or used as part of the issue pattern.

Metadata about the phase of the continuous integration and deployment process may be used to filter candidate issues. For example, an issue may be detected in the continuous integration phase, prior to the deployment of a change to a set of code. Diagnostic files may be stored in association with metadata indicating the issue was encountered during the continuous integration phase and that the code was not deployed before encountering the issue. The metadata may be used to filter candidate issues of the issue database prior to searching the issue database to exclude those candidate issues that may only be encountered after deployment of the code.

In the interest of facilitating the efficient and streamlined process that a continuous integration and continuous deployment architecture provides, many issues encountered in this architecture may be solved automatically via an autoheal solution. A managing user for a continuous integration and deployment architecture may define a setting for autoheal solutions for issues encountered in the continuous integration and continuous deployment phase. For example, the managing user may determine whether autoheal solutions may be implemented without confirmation for issues detected in the continuous integration and continuous deployment architecture. The managing user may also define a set of conditions for implementation of autoheal solutions. For example, the managing user may define that an autoheal solution may be implemented for issues detected in the continuous deployment phase. In this example, the autoheal solution may be preferred so as to maintain uptime. When implementing an autoheal solution, the autoheal solution may make further changes to the code to solve the encountered issue to create an autoheal version of the code as a new version. The autoheal version may be tested prior to deployment to determine if the encountered issue has been solved and, if not, a new autoheal solution may be applied.

Autoheal solutions within a continuous integration and continuous deployment architecture may require multiple steps to perform, such as multiple API calls to access various resources. The issue database may store a solution workflow pattern comprising the set of API calls necessary for the application of the solution. For example, a solution that inserts a dependency within a file may require the steps of determining a file location, requesting permissions for the file, accessing the file, writing to the file, and writing a log of changes for the file. The solution workflow pattern may be assigned a solution ID that may be stored as metadata for the changes made in implementing the solutions such as to a change log. In this way, a record of not only the solutions applied, but the discrete steps or actions that were performed as part of the solution may be made. When determining a solution to apply based on a determination of a similar issue of the issue database, the issue analysis system may access the solution workflow pattern to determine the set of actions necessary to implement the solution. A solution workflow pattern may specify an order of steps to apply which may be enforced, or may specify steps of the solution workflow pattern which may be performed simultaneously or in any order. A solution workflow pattern may specify a specific step as requiring user input such as user approval of an action or entering of a set of user credentials.

A solution workflow pattern may be associated with a level of risk to apply. A level of risk may be determined based on the underlying steps within the solution workflow pattern such as the API calls included. For example, a solution workflow pattern may be rated with a high level of risk if an API call within the solution workflow pattern accesses a master file or database for altering values. In another example, a solution workflow pattern may be rated with a low level of risk if all API calls within the solution workflow pattern do not influence code or files of other systems. A managing user may set a rule for the application of autoheal solutions based on the level of risk for the solution workflow pattern of the solution such that overly risky solutions may not be applied without user review but less risky solutions may be applied automatically.

### Computer System Architecture

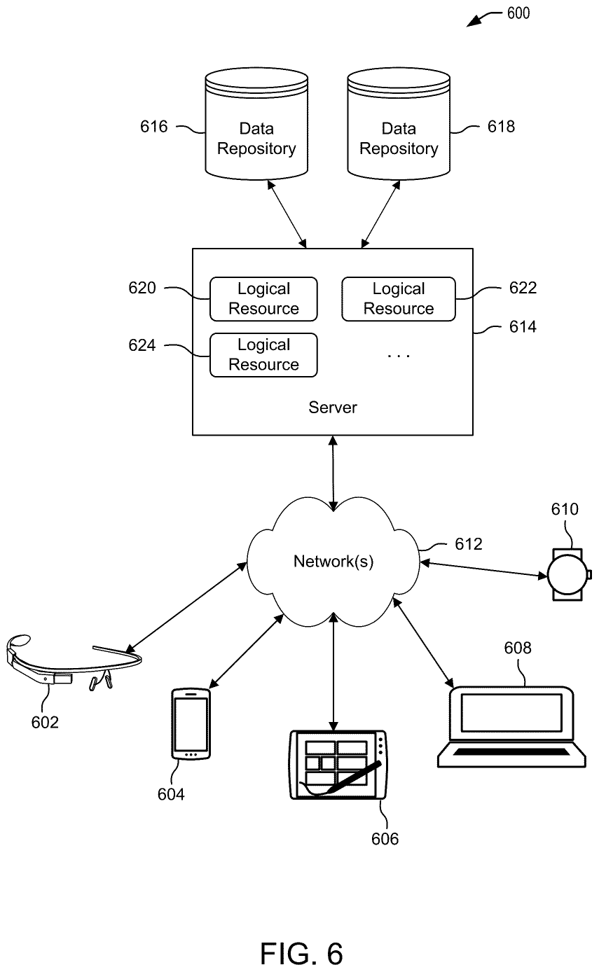

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks 612. Clients computing devices 602, 604, 606, 608, and/or 610 may be configured to execute one or more applications.

In various aspects, server 614 may be adapted to run one or more services or software applications that enable techniques for analyzing issues and presenting solutions.

In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques for analyzing issues and presenting solutions in accordance with the teachings of this disclosure. A client device may provide an interface that enables a user of the client device to interact with the client device. The client device may also output information to the user via this interface. Although FIG. 6 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 614 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

Distributed system 600 may also include one or more data repositories 616, 618. These data repositories may be used to store data and other information in certain aspects. For example, one or more of the data repositories 616, 618 may be used to store information for techniques for analyzing issues and presenting solutions. Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

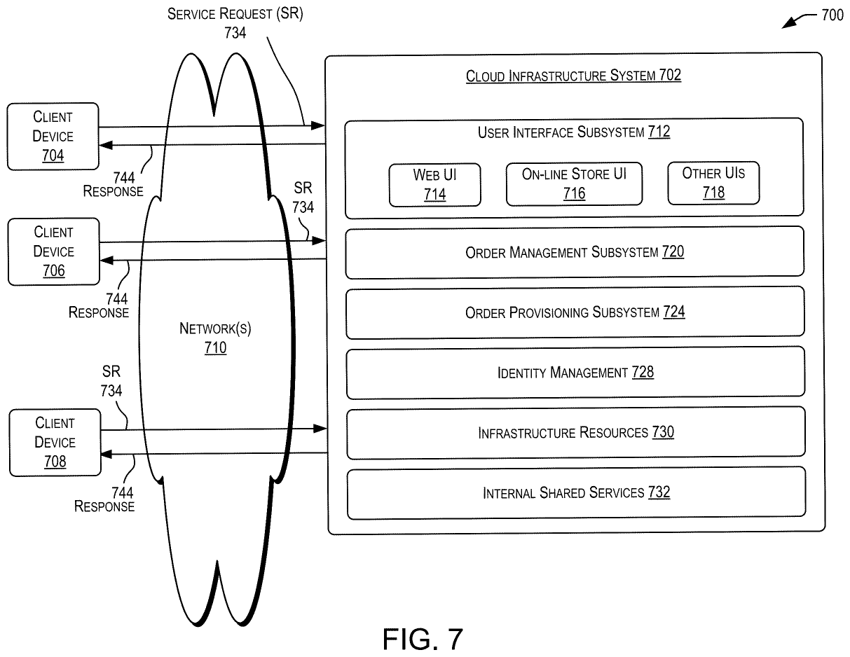

FIG. 7 is a simplified block diagram of a cloud-based system environment in which issue analysis may be performed, in accordance with certain aspects. In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 614. The computers in cloud infrastructure system 702 may be organized as general purpose computers, specialized server computers, server farms, server clusters, or any other appropriate arrangement and/or combination.

Network(s) 710 may facilitate communication and exchange of data between clients 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 702 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 702 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 702. Cloud infrastructure system 702 then performs processing to provide the services requested in the tenant's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public tenant, where the tenant can be an individual or an enterprise. In certain other aspects, under a private cloud model, cloud infrastructure system 702 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 702 and the services provided may be shared by several organizations in a related community. Various other models such as hybrids of the above mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702.

In some aspects, the processing performed by cloud infrastructure system 702 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a tenant may, using a client device, request (service request 734) one or more services provided by cloud infrastructure system 702 using one or more of interfaces 714, 716, and 718. For example, a tenant may access the online store, browse cloud services offered by cloud infrastructure system 702, and place a subscription order for one or more services offered by cloud infrastructure system 702 that the tenant wishes to subscribe to. The service request may include information identifying the tenant and one or more services that the tenant desires to subscribe to. For example, a tenant may place a subscription order for a chatbot related service offered by cloud infrastructure system 702. As part of the order, the client may provide information identifying the input (e.g. utterances).

In certain aspects, such as the embodiment depicted in FIG. 7, cloud infrastructure system 702 may comprise a service management subsystem (OMS) 720 that is configured to process the new order. As part of this processing, OMS 720 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 720 may then invoke the service provisioning subsystem (OPS) 724 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 702 may send a response or notification 744 to the requesting tenant to indicate when the requested service is now ready for use. In some instances, information (e.g., a link) may be sent to the tenant that enables the tenant to start using and availing the benefits of the requested services.

Cloud infrastructure system 702 may provide services to multiple tenants. For each tenant, cloud infrastructure system 702 is responsible for managing information related to one or more subscription orders received from the tenant, maintaining tenant data related to the orders, and providing the requested services to the tenant or clients of the tenant. Cloud infrastructure system 702 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 702 may provide services to multiple tenants in parallel. Cloud infrastructure system 702 may store information for these tenants, including possibly proprietary information. In certain aspects, cloud infrastructure system 702 comprises an identity management subsystem (IMS) 728 that is configured to manage tenant's information and provide the separation of the managed information such that information related to one tenant is not accessible by another tenant. IMS 728 may be configured to provide various security-related services such as identity services, such as information access management, authentication and authorization services, services for managing tenant identities and roles and related capabilities, and the like.

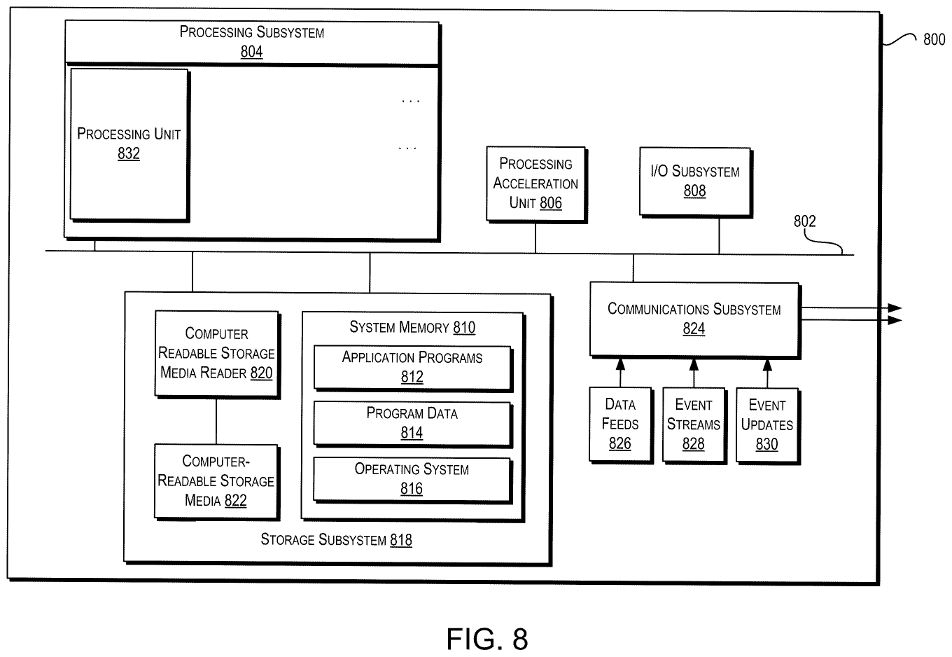

FIG. 8 illustrates an exemplary computer system 800 that may be used to implement certain aspects. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory and/or transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all of the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all of the program code to be executed can be resident in system memory 810 and/or on computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain aspects, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices. For example, the communications subsystem may be used to transmit a response to a user regarding the inquiry for a chatbot.

Communications subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communications subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a request comprising a natural language description of a particular issue;
encoding at least the natural language description of the particular issue to a particular issue vector embedding based at least in part on a model for an embedding space;
accessing a database comprising a plurality of issues associated with a plurality of different issue pattern vector embeddings as encoded by a model for the embedding space;
determining a similarity between one or more issues of the plurality of issues and the natural language description of the particular issue based at least in part on distances determined for pairs of the particular issue vector embedding and one or more individual issue pattern vector embeddings of the plurality of different issue pattern vector embeddings; wherein the one or more issue pattern vector embeddings comprise encodings of the one or more issues;
causing display of information identifying the one or more issues and one or more sets of responsive actions stored in association with the one or more issues;
receiving feedback indicating that a selected issue of the one or more issues is the particular issue, wherein the selected issue is stored in association with one or more particular sets of responsive actions of the one or more sets of responsive actions;
causing display of information identifying one or more particular actions in the one or more particular sets of responsive actions; wherein performance of the one or more particular actions is predicted to address the particular issue based at least in part on the determined similarity;
receiving feedback indicating that a selected one or more particular actions addresses the particular issue; and
adjusting a weight of the selected one or more particular actions for the selected issue based at least in part on the feedback.

2. The computer-implemented method of claim 1, wherein one or more of the plurality of different issue pattern vector embeddings are based at least in part on one or more stored diagnostic files associated with one or more of the plurality of issues, the computer-implemented method further comprising:
receiving input from a request handling user, wherein the input comprises additional details about an identified issue of the plurality of issues; and
storing the input in association with the identified issue, wherein storing the input in association with the identified issue causes an updated vector embedding to be generated for the identified issue.

3. The computer-implemented method of claim 1, wherein the one or more particular actions comprise one or more automated actions, and wherein the feedback comprises feedback on whether to perform the one or more automated actions in response to the feedback.

4. The computer-implemented method of claim 1, wherein the one or more particular actions comprise one or more automated actions, and wherein the feedback comprises feedback to automatically perform the one or more automated actions in response to other requests about the particular issue.

5. The computer-implemented method of claim 1, the computer-implemented method further comprising determining that one or more automated actions cannot be performed without additional user approval, wherein the one or more particular actions comprise the one or more automated actions, and wherein the feedback comprises the additional user approval.

6. The computer-implemented method of claim 1, wherein the one or more particular actions comprise one or more automated actions, and wherein the feedback comprises feedback to request user approval before performing the one or more automated actions in response to other requests about the particular issue.

7. The computer-implemented method of claim 1, wherein the one or more particular actions comprise one or more automated actions, and wherein the feedback comprises feedback that user approval is not needed before performing the one or more automated actions in response to other requests about the particular issue.

8. The computer-implemented method of claim 1, the computer-implemented method further comprising determining that one or more automated actions can be performed without additional user approval based at least in part on a history of feedback about the one or more automated actions; wherein the one or more particular actions comprise the one or more automated actions that are performed based at least in part on the request before the receiving the feedback.

9. The computer-implemented method of claim 1, the computer-implemented method further comprising determining that one or more automated actions can be performed without additional user approval based at least in part on a configurable setting stored in association with the one or more automated actions; wherein the one or more particular actions comprise the one or more automated actions that are performed based at least in part on the request before the receiving the feedback.

10. The computer-implemented method of claim 1, wherein the encoding, the accessing, the determining, and the adjusting are performed by a vector database that stores vector embeddings in association with data and retrieves subsets of data similar to input based at least in part on the stored vector embeddings and a vector embedding of the input.

11. The computer-implemented method of claim 1, wherein the request is a user-to-user message from a first user on a messaging platform, wherein the user-to-user message is ingested by an issue resolution platform via an application programming interface, and wherein the causing display is performed in a user session for a second user on the issue resolution platform.

12. The computer-implemented method of claim 1, wherein the plurality of issues and plurality of different issue pattern vector embeddings are stored in an issue database that is initialized with an initial knowledge base for analyzing issues, wherein determining the similarity is performed after attaching the issue database to an existing operational pipeline for handling issues, and wherein the initial knowledge base comprises information gathered outside of the existing operational pipeline.

13. The computer-implemented method of claim 1, wherein the method is performed as part of a microservice added to an existing operational pipeline, wherein the particular issue is an issue reported in the operational pipeline, and wherein the accessing is performed in response to the detection of the particular issue within the operational pipeline.

14. The computer-implemented method of claim 13, wherein the microservice comprises an endpoint which is triggered on an event completion of a software execution cycle of the operational pipeline, wherein the plurality of issues and plurality of different issue pattern vector embeddings are stored in an issue database that is initialized with an initial knowledge base for analyzing issues, and wherein the method further comprises automatically storing the particular issue, the particular issue vector embedding, and metadata related to the particular issue in the issue database.

15. The computer-implemented method of claim 1, the method further comprising:
receiving feedback indicating a user-entered one or more particular actions addresses the particular issue; and
storing the user-entered one or more particular actions in association with the selected issue.

16. A computer-program product comprising one or more non-transitory machine-readable storage media, including stored instructions configured to cause a computing system to perform a set of actions including:
accessing a request comprising a natural language description of a particular issue;
encoding at least the natural language description of the particular issue to a particular issue vector embedding based at least in part on a model for an embedding space;
accessing a database comprising a plurality of issues associated with a plurality of different issue pattern vector embeddings as encoded by a model for the embedding space;
determining a similarity between one or more issues of the plurality of issues and the natural language description of the particular issue based at least in part on distances determined for pairs of the particular issue vector embedding and one or more individual issue pattern vector embeddings of the plurality of different issue pattern vector embeddings; wherein the one or more issue pattern vector embeddings comprise encodings of the one or more issues;
causing display of information identifying the one or more issues and one or more sets of responsive actions stored in association with the one or more issues;
receiving feedback indicating that a selected issue of the one or more issues is the particular issue, wherein the selected issue is stored in association with one or more particular sets of responsive actions of the one or more sets of responsive actions;
causing display of information identifying one or more particular actions in the one or more particular sets of responsive actions; wherein performance of the one or more particular actions is predicted to address the particular issue based at least in part on the determined similarity;
receiving feedback indicating that a selected one or more particular action addresses the particular issue; and
adjusting a weight of the selected one or more particular actions for the selected issue based at least in part on the feedback.

17. The computer-program product of claim 16, wherein the one or more particular actions comprise one or more automated actions, and wherein the feedback comprises feedback on whether to perform the one or more automated actions in response to the feedback.

18. The computer-program product of claim 16, wherein the set of actions further includes determining that one or more automated actions can be performed without additional user approval based at least in part on a history of feedback about the one or more automated actions; wherein the one or more particular actions comprise the one or more automated actions that are performed based at least in part on the request before the receiving the feedback.

19. The computer-program product of claim 16, wherein the set of actions further includes determining that one or more automated actions can be performed without additional user approval based at least in part on a configurable setting stored in association with the one or more automated actions; wherein the one or more particular actions comprise the one or more automated actions that are performed based at least in part on the request before the receiving the feedback.

20. The computer-program product of claim 16, wherein the encoding, the accessing, the determining, and the adjusting are performed by a vector database that stores vector embeddings in association with data and retrieves subsets of data similar to input based at least in part on the stored vector embeddings and a vector embedding of the input.

21. A system comprising:
one or more processors; and
one or more non-transitory computer-readable media storing instructions, which, when executed by the system, cause the system to perform a set of actions including:
accessing a request comprising a natural language description of a particular issue;
encoding at least the natural language description of the particular issue to a particular issue vector embedding based at least in part on a model for an embedding space;
accessing a database comprising a plurality of issues associated with a plurality of different issue pattern vector embeddings as encoded by a model for the embedding space;
determining a similarity between one or more issues of the plurality of issues and the natural language description of the particular issue based at least in part on distances determined for pairs of the particular issue vector embedding and one or more individual issue pattern vector embeddings of the plurality of different issue pattern vector embeddings; wherein the one or more issue pattern vector embeddings comprise encodings of the one or more issues;
causing display of information identifying the one or more issues and one or more sets of responsive actions stored in association with the one or more issues;
receiving feedback indicating that a selected issue of the one or more issues is the particular issue, wherein the selected issue is stored in association with one or more particular sets of responsive actions of the one or more sets of responsive actions;
causing display of information identifying one or more particular actions in the one or more particular sets of responsive actions; wherein performance of the one or more particular actions is predicted to address the particular issue based at least in part on the determined similarity; and
adjusting a weight of the selected one or more particular actions for the selected issue based at least in part on the feedback.

22. The system of claim 21, wherein the one or more particular actions comprise one or more automated actions, and wherein the feedback comprises feedback on whether to perform the one or more automated actions in response to the feedback.

23. The system of claim 21, wherein the set of actions further includes determining that one or more automated actions can be performed without additional user approval based at least in part on a history of feedback about the one or more automated actions; wherein the one or more particular actions comprise the one or more automated actions that are performed based at least in part on the request before the receiving the feedback.

24. The system of claim 21, wherein the set of actions further includes determining that one or more automated actions can be performed without additional user approval based at least in part on a configurable setting stored in association with the one or more automated actions; wherein the one or more particular actions comprise the one or more automated actions that are performed based at least in part on the request before the receiving the feedback.
